(19) United States
(12) Patent Application Publication
(10) Pub. No.: US 2020/0266662 A1
(43) Pub. Date: Aug. 20, 2020

(54) WIRELESS CHARGING DEVICE OF GAME MACHINES

(71) Applicants: Nien-Chang HUANG, New Taipei City (TW); Yun-Ping CHEN, New Taipei City (TW); Yu-Chia HUNG, New Taipei City (TW); Hao-En HUNG, New Taipei City (TW); Po-Wen LU, New Taipei City (TW); Liang-Yi HO, New Taipei City (TW)

(72) Inventors: Nien-Chang HUANG, New Taipei City (TW); Yun-Ping CHEN, New Taipei City (TW); Yu-Chia HUNG, New Taipei City (TW); Hao-En HUNG, New Taipei City (TW); Po-Wen LU, New Taipei City (TW); Liang-Yi HO, New Taipei City (TW)

(21) Appl. No.: 16/779,608

(22) Filed: Feb. 2, 2020

(30) Foreign Application Priority Data
Feb. 19, 2019 (TW) 108202072

(51) Int. Cl. H02J 50/10; G07F 17/32; H02J 7/00

(52) U.S. Cl. CPC H02J 50/10; H02J 7/0044; G07F 17/3223

(57) ABSTRACT

A wireless charging device of game machines, which comprises a game machine, provided with at least a table top, and the table top is provided with at least a concave tray; at least a wireless charging device, located in the concave tray of the table top; there is a panel at the top of the table top of the game machine, and the panel covers the wireless charging device in the tray; the wireless charging device comprises a wireless charging part and a charging support connected to each other. Thereby, the 3C product can be charged without a USB cable, it can be directly placed on the table top with a wireless charging device of game machine for wireless charging.

### BACKGROUND OF INVENTION

### 1. Field of the Invention

The present invention relates generally to a charging device, and more particularly to a wireless charging device of a game machine for wireless charging of 3C products on the game machine.

### 2. Description of Related Art

For charging a general mobile phone, the mobile phone must be connected to a socket which supplies power via a USB cable. However, sometimes the user does not have a USB cable or the connection mismatches the mobile phone, so that the phone cannot be charged, inconvenient for the user. In addition, the most popular recreation of modern people is the games of large game machines, but sometimes the game machine and the phone charging plug are in different places. To avoid losing the mobile phone, the user cannot charge the phone while playing a game, the charging will take time if the mobile phone is at low battery, and the mobile phone at low battery cannot receive messages continuously, the practicability is degraded greatly. This is an urgent issue for the suppliers and consumers to break through.

### SUMMARY OF THE INVENTION

To solve the aforesaid deficiencies in the existing technology, the primary object of the present invention is to provide a wireless charging device of game machines, hoping to overcome the difficulties in the existing technology by the wireless charging device on the table top of a game machine.

The secondary object of the present invention is to provide a wireless charging device of game machines, which can charge 3C products without a USB cable.

Another object of the present invention is to provide a wireless charging device of game machines, the usability is enhanced effectively.

In terms of the problems to be solved by the present invention, for charging a general mobile phone, the mobile phone must be connected to a socket which supplies power via a USB cable. However, sometimes the user does not have a USB cable or the connection mismatches the mobile phone, so that the phone cannot be charged. In addition, the most popular recreation of modern people is the games of large game machines, but sometimes the game machine and the phone charging plug are in different places. To avoid losing the mobile phone, the user cannot charge the phone while playing a game, the charging will take time if the mobile phone is at low battery, and the mobile phone at low battery cannot receive messages continuously, causing inconvenience to the user, the practicability is degraded greatly.

In terms of technical means for problem solving, in order to attain the aforesaid purposes, the present invention provides a wireless charging device of game machines, which comprises

a game machine, provided with at least a table top, and the table top is provided with at least a concave tray;

at least a wireless charging device, located in the concave tray of the table top.

Wherein there is a panel on the top of the table top of the game machine, the panel covers the wireless charging device in the tray.

Wherein, the wireless charging device of the present invention comprises a wireless charging part and a charging support connected to each other, the wireless charging part is located at the upper end of the charging support.

In comparison to the effect of prior art, the game machine is provided with a table top, and the table top is provided with a wireless charging device; so that the 3C product can be charged without a USB cable, it can be directly placed on the table top with a wireless charging device of the game machine for wireless charging; the usability is enhanced effectively, meeting the progressiveness, practicability and user requirement, the gain is obvious.

### BRIEF DESCRIPTION OF THE DRAWINGS

FIG. 1: Three-dimensional exploded diagram of the present invention.

FIG. 2: Three-dimensional combined diagram of the present invention.

FIG. 3: Combined sectional view of the present invention.

FIG. 4: Embodiment of wireless charging of 3C product on the present invention.

### DETAILED DESCRIPTION OF THE INVENTION

The present invention is detailed below in embodiments with attached figures. The figures used in the text are for illustration only, not the actual scale and accurate configuration of the present invention, so the scales and configurations of the attached figures shall not limit the scope of patent of the present invention in actual implementation.

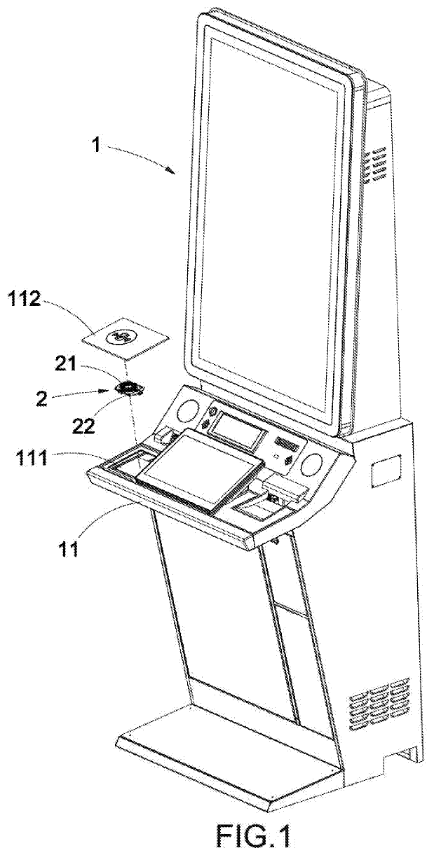

FIGS. 1-4 are the three-dimensional exploded diagram of the present invention, three-dimensional combined diagram of the present invention, combined sectional view of the present invention and the embodiment of wireless charging of 3C product on the present invention. The wireless charging device of game machines of the present invention comprises a game machine 1 and at least a wireless charging device 2 in a preferred embodiment.

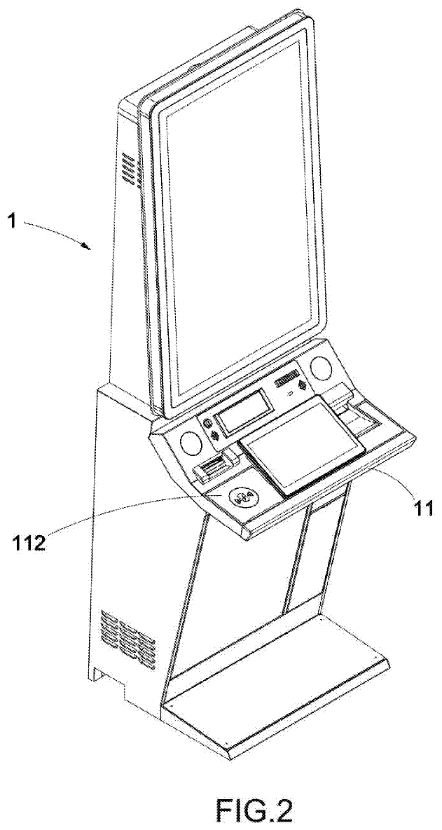

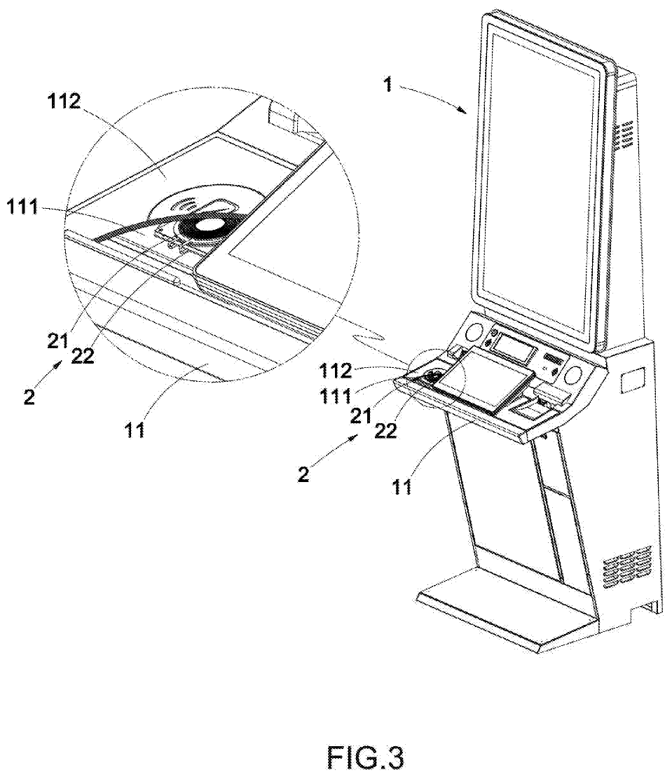

Said game machine 1 is provided with at least a table top 11, and the table top 11 is provided with at least a concave tray 111 (as shown in FIG. 1, FIG. 2 and FIG. 3).

Said at least a wireless charging device 2 is located in the concave tray 111 of the table top 11; the wireless charging device 2 of this embodiment comprises a wireless charging part 21 and a charging support 22 connected to each other. The wireless charging part 21 is located at the top of the charging support 22. In order to make the table top 11 even for placing a 3C product 3, a panel 112 is located at the top of the table top 11 of the game machine 1, and the panel 112 covers the wireless charging device 2 in the tray 111, the panel 112 of the present invention can be made of, but not limited to glass or plastics (as shown in FIG. 1, FIG. 2 and FIG. 3).

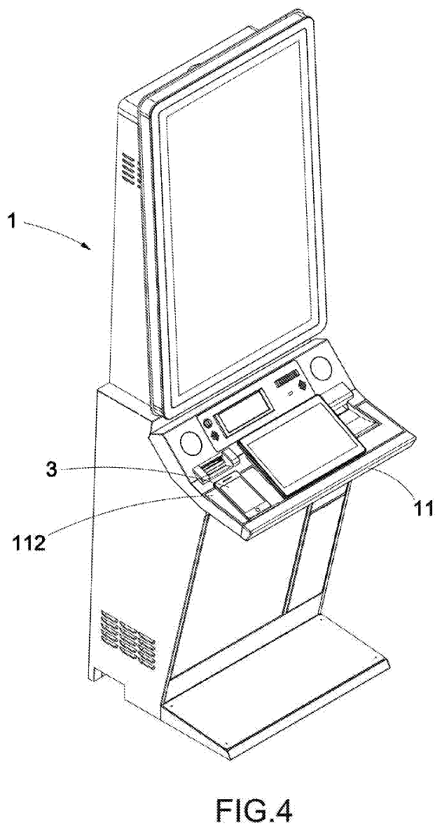

As shown in FIG. 4, the present invention can charge the 3C product 3 without a cable while the user is playing at the game machine 1, for wireless charging of the 3C product, as long as the 3C product 3 is placed on the panel 112 of the table top 11, the electricity generated by the wireless charging device 2 can be directly delivered to the 3C product 3 on the table top 112.

Thereby, the game machine 1 is provided with a table top 11, and the table top 11 is provided with a wireless charging device 2; so that the 3C product 3 can be charged without a USB cable, the table top 11 with wireless charging device 2 of game machine 1 can provide wireless charging, the usability is enhanced effectively, meeting the progressiveness, practicability and user requirement, the gain is obvious.

To sum up, the present invention has broken through prior technical structure and attained the desired effect, and it is difficult to be thought of by the persons who are not familiar with this technique. In addition, the present invention has not been disclosed before application, its originality and practicability have obviously met the essentials of application for a patent of invention. Therefore, the application for the invention is proposed according to law, your approval of the application for the patent of this invention will encourage inventions, thank you.

Although the invention has been explained in relation to its preferred embodiment, it is to be understood that many other possible modifications and variations can be made without departing from the spirit and scope of the invention as hereinafter claimed.

What is claimed is:

1. A wireless charging device of game machines, which comprises
a game machine, provided with at least a table top, and the table top is provided with at least a concave tray;
at least a wireless charging device, located in the concave tray of the table top.

2. The wireless charging device of game machines defined in claim 1, wherein a panel is located at the top of the table top of said game machine, and the panel covers the wireless charging device in the tray.

3. The wireless charging device of game machines defined in claim 1 , wherein said wireless charging device comprises a wireless charging part and a charging support connected to each other, the wireless charging part is located at the top of the charging support.

4. The wireless charging device of game machines defined in claim 2, wherein said wireless charging device comprises a wireless charging part and a charging support connected to each other, the wireless charging part is located at the top of the charging support.
